(19) United States
(12) Patent Application Publication
(10) Pub. No.: US 2025/0153478 A1
(43) Pub. Date: May 15, 2025

(54) MANUFACTURING SYSTEM AND MANUFACTURING METHOD FOR WATERPROOF FILM COMPONENT

(71) Applicant: TAIWAN TEXTILE FEDERATION, Taipei City (TW)

(72) Inventors: Shu-Hui HUANG, Taipei City (TW); Yao-Hung KUO, Taipei City (TW)

(21) Appl. No.: 18/509,217

(22) Filed: Nov. 14, 2023

(51) Int. Cl. B32B 37/10; B32B 5/02; B32B 7/12; B32B 27/12; B32B 27/36; B32B 37/00; B32B 37/06; B32B 37/12

(52) U.S. Cl. CPC B32B 37/10; B32B 5/02; B32B 7/12; B32B 27/12; B32B 27/36; B32B 37/0053; B32B 37/06; B32B 37/1207; B32B 2037/1223; B32B 2250/03; B32B 2262/0276; B32B 2305/18; B32B 2307/7265; B32B 2310/028; B32B 2367/00

(57) ABSTRACT

A manufacturing system includes: a body having an input section, a pressing section, and an output section, the pressing section located between the input section and the output section; an input roller assembly disposed in the input section, conveying a base film, a first hot melt adhesive film, and a second hot melt adhesive film; an ultrasonic device disposed on one side of the pressing section; a hot roller device disposed on the other side of the pressing section opposite to the ultrasonic device; an output roller disposed in the output section, outputting a waterproof film component. The base film, the first hot melt adhesive film, and the second hot melt adhesive film pass through the pressing section and are pressed by the ultrasonic device and the hot roller device to be the waterproof film component.

### BACKGROUND OF THE DISCLOSURE

### Technical Field

The present disclosure relates to a manufacturing system and a manufacturing method for a waterproof film component.

### Description of Related Art

The related art of combining the cloths with different materials is using the adhering technology with adhesive-type cloth layer. The technology is using adhesive to adhere different cloths, and may be applied to different fields, such as textile, leather, shoes, package, etc. The core concept of the adhering technology with adhesive-type cloth layer is using specific adhesive to polymerize the molecules on the surface of material to form sturdy combination. The adhesive may be liquid, solid, or semi-solid, which is chose according to using requirements. After the adhesive is smeared to the surface of cloth layer, a specific time period is generally required to become solidification to achieve durable bond.

However, the adhering technology with adhesive-type cloth layer needs to smear adhesive during manufacturing process and wait for solidification of adhesive, the manufacturing time of the cloth film component may be increased. Further, using adhesive may cause the risk of flashover for cloth film component, and may cause environmental pollution and increasing of recycling cost.

In view of this, the inventors have devoted themselves to the aforementioned related art, researched intensively try to provide a solution for combining the cloth layers with different materials without using adhesive.

### SUMMARY OF THE DISCLOSURE

The disclosure provides a manufacturing system and a manufacturing method for a waterproof film component, which does not need to use adhesive, and may reduce raw material, facilitate processing, decrease manufacturing time period, prevent flashover of cloth film component, and decrease recycling cost of cloth film component.

The disclosure discloses a manufacturing system for a waterproof film component, the manufacturing system including: a body, including an input section, a pressing section, and an output section, and the pressing section located between the input section and the output section; an input roller assembly, disposed in the input section, and configured to convey a base film, a first hot melt adhesive film, and a second first hot melt adhesive film; an ultrasonic device, disposed on one side of the pressing section; a hot roller device, disposed on another side of the pressing section opposite to the ultrasonic device; and an output roller, disposed in the output section, and configured to output the waterproof film component. The base film, the first hot melt adhesive film, and the second first hot melt adhesive film pass through the pressing section and are pressed by the ultrasonic device and the hot roller device to be the waterproof film component.

In some embodiments, the waterproof film component includes: a base layer; a first hot melt adhesive layer, attached on the base layer; and a second hot melt adhesive layer, attached on the first hot melt adhesive layer. The first hot melt adhesive layer, the base layer, and the second hot melt adhesive layer are made of a homologous material, and a melting point of the first hot melt adhesive layer is lower than a melting point of the second hot melt adhesive layer.

In some embodiments, the input roller assembly is configured to further convey a third hot melt adhesive film, the first hot melt adhesive film is located between the base film and the second hot melt adhesive film, and the second hot melt adhesive film is located between the first hot melt adhesive film and the third hot melt adhesive film.

In some embodiments, the ultrasonic device includes a first roller, the hot roller device includes a second roller, a first axle of the first roller is parallel or perpendicular to a second axle of the second roller.

In some embodiments, the hot roller device includes: a heating roller, disposed on one side of the pressing section; and a belt, surrounding the second roller and the heating roller.

In some embodiments, the manufacturing system further includes: a hot air device, disposed at a front end of the pressing section.

The disclosure discloses a manufacturing method for a waterproof film component, the manufacturing method including: simultaneously conveying a base film a first hot melt adhesive film, and a second hot melt adhesive film to a pressing section; using a first heating manner and an ultrasonic vibration heating manner to heat the base film, the first hot melt adhesive film, and the second hot melt adhesive film in the pressing section; pressing the base film, the first hot melt adhesive film, and the second hot melt adhesive film to generate the waterproof film component in the pressing section.

In some embodiments, the using of the first heating manner and the ultrasonic vibration heating manner to heat the base film, the first hot melt adhesive film, and the second hot melt adhesive film in the pressing section further includes: heating the base film, the first hot melt adhesive film, and the second hot melt adhesive film by a predetermined temperature range to only make the first hot melt adhesive film be in a hot melt state. The predetermined temperature range is greater than or equal to a first melting temperature of the first hot melt adhesive film and equal to or less than a second melting temperature of the second hot melt adhesive film, and the second melting temperature is equal to the first melting temperature plus about 160° C.

In some embodiments, the first heating manner includes: using a hot roller device to contact and heat the base film, the first hot melt adhesive film, and the second hot melt adhesive film.

In some embodiments, the ultrasonic vibration heating manner includes: using an ultrasonic device to output a fixed power to vibrate and heat the base film, the first hot melt adhesive film, and the second hot melt adhesive film.

In summary, the related-art cloth layer attaching method has the disadvantages as below: the adhesive needs to be smeared during manufacturing process and waiting for solidification, which cause the increasing of manufacturing time period for the cloth film component; some adhesives need specific processing, such as solidification under specific temperature or special procedure, to ensure durability and strength for bonding; using adhesive may cause the risk of flashover for cloth film component, and cause environmental pollution and the increasing of recycling cost.

Comparing to the related art, the disclosure may have following advantages from manufacturing process perspective: reducing raw materials, facilitating processing, decreasing manufacturing time period, no need for specific processing, lowering the noise produced by the ultrasonic device, and preventing skewing between the cloths during heating, pressing, and conveying.

The disclosure may have following advantages from product perspective: the waterproof film component may be used as the waterproof film component or the waterproof hot melt adhesive; the peel strength between the base layer and the second hot melt adhesive layer may reach 200 grams per centimeter; the waterproof function may reach 10 times of water washing; the water pressure resistance may reach 5000 mmH₂O; the risk of flashover for cloth film component may be prevented; and a better attaching (bonding) effect may be achieved.

The disclosure may have following advantages from recycling perspective: decreasing the recycling cost; and facilitating recycling and re-using.

### BRIEF DESCRIPTION OF THE DRAWINGS

FIG. 1 is a schematic diagram of one embodiment of the manufacturing system of the disclosure.

FIG. 2 is a schematic diagram of the variant embodiment of the manufacturing system of the disclosure.

FIG. 3 is a flowchart of the manufacturing method of the disclosure.

FIG. 4 is a schematic diagram of one embodiment of the waterproof film component of the disclosure.

FIG. 5 is a schematic diagram of the variant embodiment of the waterproof film component of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

As used herein, terms such as “first”, “second”, “third”, “fourth” and “fifth” are used to describe elements, components, regions, layers and/or parts, but the elements, components, regions, layers and/or parts should not be restricted by these terms. These terms are only used to distinguish an element, component, region, layer or part from another, and the use of these terms including “first”, “second”, “third”, “fourth” and “fifth” in this specification does not imply their order or sequence unless the context clearly indicates otherwise.

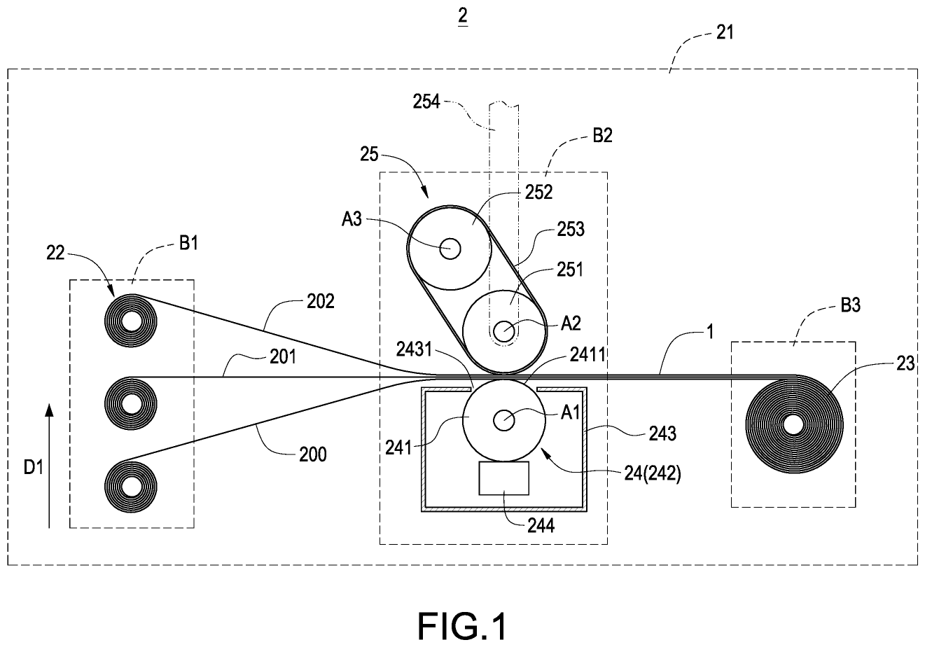

FIG. 1 is a schematic diagram of one embodiment of the manufacturing system 2 for the waterproof film component 1 of the disclosure. As shown in FIG. 1, the manufacturing system 2 is used to manufacture the waterproof film component 1. The manufacturing system 2 includes a body 21, an input roller assembly 22, an ultrasonic device 24, a hot roller device 25, and an output roller 23.

The body 21 has an input section B1, a pressing section B2, and an output section B3. The pressing section B2 is located between the input section B1 and the output section B3. In the embodiment, for example, the input section B1, the pressing section B2, and the output section B3 are sequentially located from left to right in the FIG. 1. The input section B1 is an area configured to store and convey a base film 200, a first hot melt adhesive film 201, and a second hot melt adhesive film 202. The pressing section B2 is an area configured to press the base film 200, the first hot melt adhesive film 201, and the second hot melt adhesive film 202. The output section B3 is an area configured to convey and store the waterproof film component 1. In other words, the base film 200, the first hot melt adhesive film 201, and the second hot melt adhesive film 202 are conveyed from the input section B1 to the pressing section B2 for pressing, and further conveyed to the output section B3 for storing.

The input roller assembly 22 is disposed in the input section B1, and configured to convey the base film 200, the first hot melt adhesive film 201, and the second hot melt adhesive film 202. In the embodiment, the input roller assembly 22, for example, may include three input rollers disposed in the input section B1. The rotating axle (which is normal direction of paper surface) of the three input rollers are parallel to one another. The three input rollers store and convey the base film 200, the first hot melt adhesive film 201, and the second hot melt adhesive film 202, respectively.

The ultrasonic device 24 is disposed on one side of the pressing section B2. In the embodiment, the ultrasonic device 24 includes a casing 243, a first roller 241, and an ultrasonic generating module 244. The casing 243 may have opening 2431 defined thereon, and is located on one side of the pressing section B2. In the embodiment, the casing 243 is located at the lower side. In other words, the base film 200, the first hot melt adhesive film 201, and the second hot melt adhesive film 202 pass through the upper side of the casing 243 and the first roller 241. The first roller 241 is axially connected to the casing 243. The arcuate portion 2411 of the first roller 241 is disposed protrusively from the opening 2431 of the casing 243, which may drive and convey the base film 200, the first hot melt adhesive film 201, and the second hot melt adhesive film 202. The ultrasonic generating module 244 is disposed on the casing 243 and connected with the first roller 241. Thus, the first roller 241 may generate vibration when receiving the ultrasonic wave generated by the ultrasonic generating module 244. In some embodiments, the ultrasonic generating module 244 may generate a vibration frequency greater than or equal to 20 kHz and less than or equal to 70 kHz. In some embodiments, a diameter of the first roller 241 is about 8 mm. When the first roller 241 rotates, the tangential speed on the surface of the first roller 241 is, for example, about 2 m/min, or greater than or equal to about 8 m/min and less than or equal to 10 m/min.

In some embodiments, the ultrasonic device 24 may be a constant frequency ultrasonic device 242. Constant frequency indicates that, when the output power is set and the ultrasonic device 24 is activated, the outputted ultrasonic power of the ultrasonic device 24 is constant. In other words, when the ultrasonic device 24 is set up for the output power and activated, the output power may not be automatically adjusted during operation, and may only be adjusted manually.

The hot roller device 25 is disposed on the other side of the pressing section B2 opposite to the ultrasonic device 24. In the embodiment, the hot roller device 25 includes a second roller 251, a heating roller 252, a belt 253, and a lifting assembly 254.

The second roller 251 is disposed on the other side opposite to the ultrasonic device 24. In the embodiment, the second roller 251 is located on the upper side. In other words, the base film 200, the first hot melt adhesive film 201, and the second hot melt adhesive film 202 pass through the lower side of the second roller 251, and the upper side of the casing 243 and first roller 241 of the ultrasonic device 24. In the embodiment, the second axle A2 of the second roller 251 is parallel to the first axle A1 of the first roller 241. If the first roller 241 is arranged as rotating clockwise along the first axle A1, the second roller 251 is arranged as rotating counterclockwise along the second axle A2. If the first roller 241 is arranged as rotating counterclockwise along the first axle A1, the second roller 251 is arranged as rotating clockwise along the second axle A2. In other words, the rotation directions between the first roller 241 and the second roller 251 are opposite to each other. As a result, the first roller 241 and the second roller 251 may simultaneously rotate and convey the base film 200, the first hot melt adhesive film 201, and the second hot melt adhesive film 202 during the process of heating and pressing the base film 200, the first hot melt adhesive film 201, and the second hot melt adhesive film 202.

The heating roller 252 is disposed on one side of the pressing section B2. In the embodiment, the third axle A3 of the heating roller 252 is parallel to the second axle A2 of the second roller 251. If the second roller 251 is arranged as rotating clockwise along the second axle A2, the heating roller 252 is arranged as rotating clockwise along the third axle A3. If the second roller 251 is arranged as rotating counterclockwise along the second axle A2, the heating roller 252 is arranged as rotating counterclockwise along the third axle A3. In other words, the rotation directions between the second roller 251 and the heating roller 252 is the same. The heating roller 252, for example, may include an electrothermal heating source.

The belt 253 surrounds the second roller 251 and the heating roller 252. The material of the belt 253 may be spiny surface metal belt. The belt 253 is used to thermally conduct the heat energy generated by the electrothermal heating source of the heating roller 252 to the second roller 251. When the second roller 251 and the heating roller 252 rotate, the belt 253 is driven to increase efficiency of conducting the heat energy from the heating roller 252 to the second roller 251.

The lifting assembly 254 is disposed on the second axle A2 of the second roller 251, and may move upward and downward to make the second roller 251 move upward and downward.

When the base film 200, the first hot melt adhesive film 201, and the second hot melt adhesive film 202 need to be heated and pressed, the lifting assembly 254 may move downward to make the second roller 251 move downward and contact the base film 200, the first hot melt adhesive film 201, and the second hot melt adhesive film 202 to perform heating and pressing.

As a result, for example, when the base film 200, the first hot melt adhesive film 201, and the second hot melt adhesive film 202 pass through the pressing section B2, the base film 200, the first hot melt adhesive film 201, and the second hot melt adhesive film 202 are heated up by the hot roller device 25 in a contact manner and by the ultrasonic device 24 in a vibration manner. In some embodiments, the base film 200, the first hot melt adhesive film 201, and the second hot melt adhesive film 202 are heated to greater than or equal to about 95° C. and less than or equal to about 252° C. to only make the first hot melt adhesive film 201 be in a hot melt state, and the base film 200 and the second hot melt adhesive film 202 are not in the hot melt state. Further, the base film 200, the first hot melt adhesive film 201, and the second hot melt adhesive film 202 are pressed to be the waterproof film component 1 by the first roller 241 of the ultrasonic device 24 and the second roller 251 of the hot roller device 25.

The output roller 23 is disposed in the output section B3, and configured to output the waterproof film component 1. In the embodiment, the rotating axle of the output roller 23 is arranged parallelly with the rotating axle of the input roller assembly 22. When the pressing of the waterproof film component 1 is finished, the output roller 23 may rotate to convey and store the waterproof film component 1.

In summary, in the related-art cloth layer attaching method, the connecting material types need to be determined, and the material needs to be prepared for ensuring that the surface is clean, no dust and no grease. Based on the characteristics, applying requirement, and expected bonding effect of the material, suitable adhesive may be selected. The selection of the adhesive may be affected by the factors, such as environmental tolerance, flexibility, strength, etc. The adhesive may be uniformly smeared on the material surface to be adhered by the tools, such as brush, roller, spraying, etc. Then, the pressing is performed on the material surface with the adhesive by different manners, such as mechanical pressure roller, hand pressing, etc., depending on the applying requirements to ensure that the adhesive is uniformly distributed. The adhesive needs a specific time period for solidification. During solidification, the chemical reaction in the adhesive makes the structure sturdy to achieve bonding. When the adhesive is solidified, certain time period is still needed for ensuring the bonding to achieve sufficient strength.

The related-art cloth layer attaching method has the disadvantages as below: the adhesive needs to be smeared during manufacturing process and waiting for solidification, which cause the increasing of manufacturing time period for the cloth film component; some adhesives need specific processing, such as solidification under specific temperature or special procedure, to ensure durability and strength for bonding; using adhesive may cause the risk of flashover for cloth film component, and cause environmental pollution and the increasing of recycling cost.

Comparing to the related art, in the manufacturing system 2 of the embodiment, after the user puts the base film 200, the first hot melt adhesive film 201, and the second hot melt adhesive film 202 on the input roller assembly 22, the input roller assembly 22 conveys the base film 200, the first hot melt adhesive film 201, and the second hot melt adhesive film 202 to the pressing section B2. The base film 200, the first hot melt adhesive film 201, and the second hot melt adhesive film 202 are directly heated and pressed by the ultrasonic device 24 and the hot roller device 25, and further conveyed to the output roller 23 for storing. Since the manufacturing system 2 of the embodiment does not need the adhesive, the raw material may be reduced, the processing may be more convenient, the manufacturing time period may be decreased, specific processing may not be needed, the risk of flashover for the cloth film component may be prevented, and the recycling cost of the cloth film component may be reduced. Further, the hot roller device 25 of the manufacturing system 2 of the embodiment may assist heating, and the ultrasonic device 24 does not need to output enormous power. Thus, that may effectively prevent the cloth from overheating to greater than or equal to about 300° C. to be degenerated due to thermal cracking, and a better bonding effect may be achieved and the noise from the ultrasonic device 24 may be decreased. It is worth mentioning that the second axle A2 of the second roller 251 is parallel to the first axle A1 of the first roller 241 to facilitate the operation for the user, and skewing between the base film 200, the first hot melt adhesive film 201, and the second hot melt adhesive film 202 during heating, pressing, and conveying may be prevented.

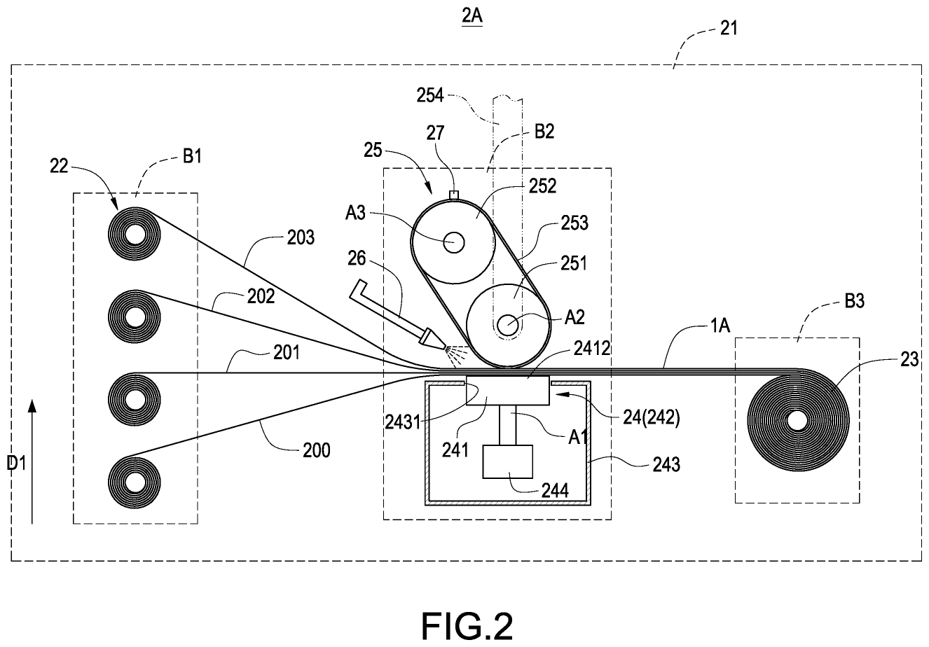

FIG. 2 is a schematic diagram of the variant embodiment of the manufacturing system 2A of the disclosure. As shown in FIG. 2, the manufacturing system 2A may further include a hot air device 26 and a temperature sensor 27, and the input roller assembly 22 may further convey a third hot melt adhesive film 203. Moreover, the first axle A1 of the first roller 241 in the ultrasonic device 24 is perpendicular to the second axle A2 of the second roller 251 in the hot roller device 25.

The hot air device 26 may be disposed at a front side of the pressing section B2. The hot air device 26 may be, for example, industrial heat gun, hot air dryer, or fan heater, etc., here is not intended to be limiting.

The temperature sensor 27 may be disposed on the hot roller device 25. The temperature sensor 27 may be, for example, bimetal thermometer, thermocouple thermometer, thermistor thermometer, infrared thermometer, etc., here is not intended to be limiting. The temperature sensor 27 is used to measure the surface temperature of the heating roller 252.

The input roller assembly 22 may convey the third hot melt adhesive film 203. The first hot melt adhesive film 201 is located between the base film 200 and the second hot melt adhesive film 202, and the second hot melt adhesive film 202 is located between the first hot melt adhesive film 201 and the third hot melt adhesive film 203. In the embodiment, the input roller assembly 22, for example, may include fore input rollers disposed in the input section B1. The rotating axles of the four input rollers are parallel to one another. The four input rollers are used to store and convey the base film 200, the first hot melt adhesive film 201, the second hot melt adhesive film 202, and the third hot melt adhesive film 203.

The first axle A1 of the first roller 241 is perpendicular to the second axle A2 of the second roller 251. In the embodiment, the direction of the second axle A2 is the normal direction of paper surface. The first roller 241 is axially connected to the ultrasonic generating module 244, and the round surface portion 2412 of the first roller 241 is disposed protrusively from the opening 2431 of the casing 243 to drive the base film 200, the first hot melt adhesive film 201, the second hot melt adhesive film 202, and the third hot melt adhesive film 203. The first roller 241 may generate vibration when receiving the ultrasonic wave generated by the ultrasonic generating module 244.

As a result, when the base film 200, the first hot melt adhesive film 201, the second hot melt adhesive film 202, and the third hot melt adhesive film 203 pass through the pressing section B2, the base film 200, the first hot melt adhesive film 201, the second hot melt adhesive film 202, and the third hot melt adhesive film 203 are firstly heated by the hot air device 26 to make the first hot melt adhesive film 201 and the third hot melt adhesive film 203 change to glass transition state to be heated up by the hot roller device 25 in a contact manner and by the ultrasonic device 24 in a vibration manner. In some embodiments, the base film 200, the first hot melt adhesive film 201, the second hot melt adhesive film 202, and the third hot melt adhesive film 203 are heated to greater than or equal to about 95° C. and less than or equal to about 252° C. to make the first hot melt adhesive film 201 and the third hot melt adhesive film 203 be in a hot melt state, and the base film 200 and the second hot melt adhesive film 202 are not in the hot melt state. Further, the base film 200, the first hot melt adhesive film 201, the second hot melt adhesive film 202, and the third hot melt adhesive film 203 are pressed to be the waterproof film component 1A by the first roller 241 of the ultrasonic device 24 and the second roller 251 of the hot roller device 25. The waterproof film component 1A may also be called as the waterproof hot melt adhesive.

Moreover, the manufacturing system 2A of the embodiment is using the hot air device 26 to assist heating, and the ultrasonic device 24 may not need to output enormous power. Thus, that may effectively prevent the cloth from overheating to greater than or equal to about 300° C. to be degenerated due to thermal cracking, and a better bonding effect may be achieved and the noise from the ultrasonic device 24 may be decreased. It is worth mentioning that the second axle A2 of the second roller 251 is perpendicular to the first axle A1 of the first roller 241 and the first roller 241 is axially connected to the ultrasonic device 24, therefore, the first roller 241 may efficiently generate vibration with better receiving the ultrasonic wave generated by the ultrasonic generating module 244 to save energy. Further, the waterproof film component TA may be used as waterproof hot melt adhesive. In other words, the user may attach the waterproof film component 1A to the other cloth, which needs the function of the waterproof film component TA, and the waterproof film component 1A (waterproof hot melt adhesive) may be attached to the other cloth after being heated.

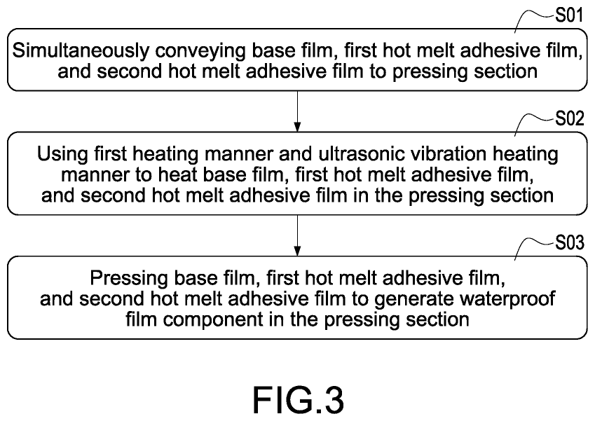

FIG. 3 is a flowchart of the manufacturing method of the disclosure. As shown in FIG. 3, the step S01 is simultaneously conveying a base film a first hot melt adhesive film, and a second hot melt adhesive film to a pressing section. The step S02 is using a first heating manner and an ultrasonic vibration heating manner to heat the base film, the first hot melt adhesive film, and the second hot melt adhesive film in the pressing section. The step S03 is pressing the base film, the first hot melt adhesive film, and the second hot melt adhesive film to generate the waterproof film component in the pressing section.

Referring to FIG. 1 and FIG. 3, in the step SO1, the base film 200, the first hot melt adhesive film 201, and the second hot melt adhesive film 202 are simultaneously conveyed to the pressing section B2. The input roller assembly 22 is aligned sequentially in a predetermined direction D1 to simultaneously convey the base film 200, the first hot melt adhesive film 201, and the second hot melt adhesive film 202 to the pressing section B2. When each roller in the input roller assembly 22 rotates, the tangential speeds on all surfaces of the rollers are kept the same. The tangential speed is, for example, about 2 m/min, or greater than or equal to about 8 m/min and less than or equal to 10 m/min.

In the step S02, the first heating manner and the ultrasonic vibration heating manner are used to heat the base film 200, the first hot melt adhesive film 201, and the second hot melt adhesive film 202 in the pressing section B2.

The first heating manner, for example, may include using a hot roller device 25 to contact and heat the base film 200, the first hot melt adhesive film 201, and the second hot melt adhesive film 202. The heating roller 252 of the hot roller device 25 heats up the belt 253, and the belt 253 conducts the heat to the second roller 251. The lifting assembly 254 move downward to contact the base film 200, the first hot melt adhesive film 201, and the second hot melt adhesive film 202 for heating and pressing.

The ultrasonic vibration heating manner, for example, may include using an ultrasonic device 24 to vibrate and heat the base film 200, the first hot melt adhesive film 201, and the second hot melt adhesive film 202. The first roller 241 of the ultrasonic device 24 may generate vibration when receiving the ultrasonic wave generated by the ultrasonic generating module 244 of the ultrasonic device 24, and transfer energy to surfaces of the base film 200, the first hot melt adhesive film 201, and the second hot melt adhesive film 202 to make the molecules vibrate frictionally to generate heat. In some embodiments, the ultrasonic device 24 may output a fixed power to vibrate and heat the base film 200, the first hot melt adhesive film 201, and the second hot melt adhesive film 202.

The base film 200, the first hot melt adhesive film 201, and the second hot melt adhesive film 202 are heated by a predetermined temperature range through collectively using the first heating manner and the ultrasonic vibration heating manner. The predetermined temperature range is greater than or equal to a first melting temperature of the first hot melt adhesive film 201 and equal to or less than a second melting temperature of the second hot melt adhesive film 202. For example, when the first hot melt adhesive film 201 and the second hot melt adhesive film 202 are selected from polyester elastane, the predetermined temperature range is greater than or equal to about 95° C. and less than or equal to about 252° C. In other words, the second melting temperature is equal to the first melting temperature plus about 160° C. to only make the first hot melt adhesive film 201 be in a hot melt state. That is, only the first hot melt adhesive film 201 is in a hot melt state, and the base film 200 and the second hot melt adhesive film 202 are not in the hot melt state.

In the step S03, the base film 200, the first hot melt adhesive film 201, and the second hot melt adhesive film 202 are pressed in the pressing section to generate the waterproof film component 1. The lifting assembly 254 of the hot roller device 25 moves downward to make the second roller 251 close to the first roller 241 of the ultrasonic device 24 and press the base film 200, the first hot melt adhesive film 201, and the second hot melt adhesive film 202 to be the waterproof film component 1. When the base film 200, the first hot melt adhesive film 201, and the second hot melt adhesive film 202 are conveying to the output section B3 from the pressing section B2, the first hot melt adhesive film 201 is cooled into the solid state to firmly bond the base film 200 and the second hot melt adhesive film 202.

In some embodiments, after the step S03, the waterproof film component 1 may be conveyed to the output section B3 for storage.

It is worth mentioning that, if the manufacturing system 2A in the FIG. 2 is incorporated, in some embodiments, before the step SO1, the base film 200, the first hot melt adhesive film 201, the second hot melt adhesive film 202, and the third hot melt adhesive film 203 may be heated by the hot air from the hot air device 26 before the pressing section B2. The hot air may make the first hot melt adhesive film 201 and the third hot melt adhesive film 203 reach the glass transition temperature to change to the glass transition state, and make the molecular chain of the first hot melt adhesive film 201 and the third hot melt adhesive film 203 move. The step S01, for example, may include simultaneously conveying the base film 200, the first hot melt adhesive film 201, the second hot melt adhesive film 202 and the third hot melt adhesive film 203 to the pressing section B2. The base film 200, the first hot melt adhesive film 201, the second hot melt adhesive film 202, and the third hot melt adhesive film 203 are aligned sequentially in the predetermined direction D1. The input roller assembly 22 of the manufacturing system 2A is aligned sequentially in the predetermined direction D1 to simultaneously convey the base film 200, the first hot melt adhesive film 201, the second hot melt adhesive film 202, and the third hot melt adhesive film 203 to the pressing section B2. When each roller in the input roller assembly 22 rotates, the tangential speeds on all surfaces of the rollers are kept the same. The tangential speed is, for example, about 2 m/min, or greater than or equal to about 8 m/min and less than or equal to 10 m/min.

Further, the step S02 further includes using the first heating manner and the ultrasonic vibration heating manner to heat the base film 200, the first hot melt adhesive film 201, the second hot melt adhesive film 202, and the third hot melt adhesive film 203 in the pressing section B2.

Moreover, the step S03 further includes pressing the base film 200, the first hot melt adhesive film 201, the second hot melt adhesive film 202, and the third hot melt adhesive film 203 in the pressing section B2 to generate the waterproof film component 1A.

In summary, in the related-art cloth layer attaching method, the connecting material types need to be determined, and the material needs to be prepared for ensuring that the surface is clean, no dust and no grease. Based on the characteristics, applying requirement, and expected bonding effect of the material, suitable adhesive may be selected. The selection of the adhesive may be affected by the factors, such as environmental tolerance, flexibility, strength, etc. The adhesive may be uniformly smeared on the material surface to be adhered by the tools, such as brush, roller, spraying, etc. Then, the pressing is performed on the material surface with the adhesive by different manners, such as mechanical pressure roller, hand pressing, etc., depending on the applying requirements to ensure that the adhesive is uniformly distributed. The adhesive needs a specific time period for solidification. During solidification, the chemical reaction in the adhesive makes the structure sturdy to achieve bonding. When the adhesive is solidified, certain time period is still needed for ensuring the bonding to achieve sufficient strength.

The related-art cloth layer attaching method has the disadvantages as below: the adhesive needs to be smeared during manufacturing process and waiting for solidification, which cause the increasing of manufacturing time period for the cloth film component; some adhesives need specific processing, such as solidification under specific temperature or special procedure, to ensure durability and strength for bonding; using adhesive may cause the risk of flashover for cloth film component, and cause environmental pollution and the increasing of recycling cost.

Comparing to the related art, in the manufacturing method of the embodiment, after the user puts the base film 200, the first hot melt adhesive film 201, and the second hot melt adhesive film 202 on the input roller assembly 22, the input roller assembly 22 simultaneously conveys the base film 200, the first hot melt adhesive film 201, and the second hot melt adhesive film 202 to the pressing section B2. The base film 200, the first hot melt adhesive film 201, and the second hot melt adhesive film 202 are heated by the first heating manner and the ultrasonic vibration heating manner and pressed in the pressing section B2 to generate the waterproof film component 1. Since the manufacturing method of the embodiment does not need the adhesive, the raw material may be reduced, the processing may be more convenient, the manufacturing time period may be decreased, specific processing may not be needed, the risk of flashover for the cloth film component may be prevented, and the recycling cost of the cloth film component may be reduced. Further, the base film 200, the first hot melt adhesive film 201, and the second hot melt adhesive film 202 are heated by the predetermined temperature range through collectively using the first heating manner and the ultrasonic vibration heating manner. The predetermined temperature range is greater than or equal to about 95° C. and less than or equal to about 252° C. to only make the first hot melt adhesive film 201 be in a hot melt state. Thus, that may effectively prevent the cloth from overheating to greater than or equal to about 300° C. to be degenerated due to thermal cracking, and a better bonding effect may be achieved and the noise from the ultrasonic device 24 may be decreased.

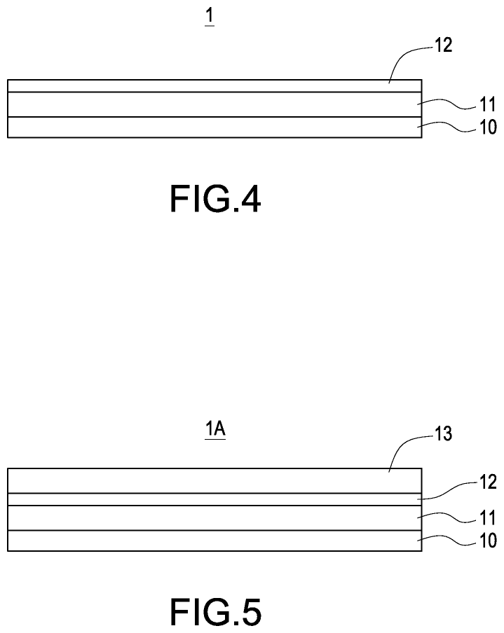

FIG. 4 is a schematic diagram of one embodiment of the waterproof film component 1 of the disclosure. As shown in FIG. 4, the waterproof film component 1 includes a base layer 10, a first hot melt adhesive layer 11, and a second hot melt adhesive layer 12. The waterproof film component 1 may be formed by the manufacturing system 2 in FIG. 1 and the manufacturing method in FIG. 3, here is not intended to be limiting.

In the embodiment, the base layer 10 may be, for example, selected from polyester waterproof cloth material. In some embodiments, the thickness of the polyester waterproof cloth material is, for example, 0.15 mm. The base layer 10 is used to let the waterproof film component 1 have waterproof function on one side.

The first hot melt adhesive layer 11 is attached on the base layer 10. In the embodiment, the first hot melt adhesive layer 11 may be, for example, selected from polyester material. The melting point of the first hot melt adhesive layer 11 is lower than the melting point of the second hot melt adhesive layer 12. The difference between the melting point of the first hot melt adhesive layer 11 and the melting point of the second hot melt adhesive layer 12 is greater than or equal to about 90° C. and less than or equal to about 160° C. In some embodiments, the melting point of the first hot melt adhesive layer 11 is about 95° C., and the melting points of the base layer 10 and the second hot melt adhesive layer 12 are about 252° C. As a result, when the temperature of the base layer 10, the first hot melt adhesive layer 11, and the second hot melt adhesive layer 12 is greater than or equal to about 95° C. and less than or equal to about 252° C., only the first hot melt adhesive layer 11 becomes the hot melt state to facilitate pressing. Further, in some embodiments, since the base layer 10 and the second hot melt adhesive layer 12 do not become the hot melt state, the waterproof capability of the base layer 10 and the second hot melt adhesive layer 12 is remained. In other words, the base layer 10 and the second hot melt adhesive layer 12 may not flow and form gap or hole due to the hot melt state and pressing, and the waterproof capability is remained.

The second hot melt adhesive layer 12 is attached on the first hot melt adhesive layer 11. In the embodiment, the second hot melt adhesive layer 12 may be, for example, selected from waterproof polyester material. In other words, the base layer 10, the first hot melt adhesive layer 11, and the second hot melt adhesive layer 12 are made of homologous material, and are all polyester material.

In summary, the waterproof film component 1 of the embodiment solves the problem in the related art that the adhesive is used to bond cloths and the waterproof film is difficult to recycle. The base layer 10, the first hot melt adhesive layer 11, and the second hot melt adhesive layer 12 are homologous material to facilitate the recycling and reusage of the waterproof film component 1. Further, the peel strength between the base layer 10 and the second hot melt adhesive layer 12 may reach 200 grams per centimeter, the waterproof function may reach 10 times of water washing, and the water pressure resistance may reach 5000 mmH₂O.

FIG. 5 is a schematic diagram of the variant embodiment of the waterproof film component 1A of the disclosure. The difference between the waterproof film component 1A and the waterproof film component 1 is that the waterproof film component 1A further includes a third hot melt adhesive layer 13 attached on the second hot melt adhesive layer 12, and the third hot melt adhesive layer 13 and the first hot melt adhesive layer are made of homologous material.

The third hot melt adhesive layer 13 may be, for example, selected from polyester material. In some embodiments, the melting points of the first hot melt adhesive layer 11 and the third hot melt adhesive layer 13 are about 95° C., and the melting points of the base layer 10 and the second hot melt adhesive layer 12 are about 252° C. It should be noted that the waterproof film component 1A may be formed by the manufacturing system 2A in FIG. 2, here is not intended to be limiting.

As a result, when the temperature of the base layer 10, the first hot melt adhesive layer 11, the second hot melt adhesive layer 12, and the third hot melt adhesive layer 13 is greater than or equal to about 95° C. and less than or equal to about 252° C., only the first hot melt adhesive layer 11 and the third hot melt adhesive layer 13 become the hot melt state to facilitate pressing. Further, in some embodiments, since the base layer 10 and the second hot melt adhesive layer 12 do not become the hot melt state, the waterproof capability of the base layer 10 and the second hot melt adhesive layer 12 is remained. In other words, the base layer 10 and the second hot melt adhesive layer 12 may not flow and form gap or hole due to the hot melt state and pressing, and the waterproof capability is remained. Moreover, since the melting points of the third hot melt adhesive layer 13 is about 95° C., the waterproof film component 1A may be used as waterproof hot melt adhesive. In other words, the user may attach the waterproof film component 1A to the other cloth, which needs the function of the waterproof film component 1A, and the waterproof film component 1A (waterproof hot melt adhesive) may be attached to the other cloth after being heated.

In summary, the related-art cloth layer attaching method has the disadvantages as below: the adhesive needs to be smeared during manufacturing process and waiting for solidification, which cause the increasing of manufacturing time period for the cloth film component; some adhesives need specific processing, such as solidification under specific temperature or special procedure, to ensure durability and strength for bonding; using adhesive may cause the risk of flashover for cloth film component, and cause environmental pollution and the increasing of recycling cost.

Comparing to the related art, the disclosure may have following advantages from manufacturing process perspective: reducing raw materials, facilitating processing, decreasing manufacturing time period, no need for specific processing, lowering the noise produced by the ultrasonic device, and preventing skewing between the cloths during heating, pressing, and conveying.

The disclosure may have following advantages from product perspective: the waterproof film component may be used as the waterproof film component or the waterproof hot melt adhesive; the peel strength between the base layer and the second hot melt adhesive layer may reach 200 grams per centimeter; the waterproof function may reach 10 times of water washing; the water pressure resistance may reach 5000 mmH₂O; the risk of flashover for cloth film component may be prevented; and a better attaching (bonding) effect may be achieved.

The disclosure may have following advantages from recycling perspective: decreasing the recycling cost; and facilitating recycling and re-using.

As used herein and not otherwise defined, the terms “substantially” and “approximately” are used to describe and depict small changes. When applied to an event or situation, these terms may encompass the exact moment of the event or situation, as well as a point close in proximity to the occurrence of the event or situation. For example, when applied to a numerical value, these terms may encompass a range of variation less than or equal to ±10% of that numerical value, such as less than or equal to ±5%, less than or equal to ±4%, less than or equal to ±3%, less than or equal to ±2%, less than or equal to ±1%, less than or equal to +0.5%, less than or equal to ±0.1%, or less than or equal to ±0.05%.

While this disclosure has been described by means of specific embodiments, numerous modifications and variations may be made thereto by those skilled in the art without departing from the scope and spirit of this disclosure set forth in the claims.

What is claimed is:

1. A manufacturing system for a waterproof film component, the manufacturing system comprising:
a body, comprising an input section, a pressing section, and an output section, and the pressing section located between the input section and the output section;
an input roller assembly, disposed in the input section, and configured to convey a base film, a first hot melt adhesive film, and a second first hot melt adhesive film;
an ultrasonic device, disposed on one side of the pressing section;
a hot roller device, disposed on another side of the pressing section opposite to the ultrasonic device; and
an output roller, disposed in the output section, and configured to output the waterproof film component,
wherein the base film, the first hot melt adhesive film, and the second first hot melt adhesive film pass through the pressing section and are pressed by the ultrasonic device and the hot roller device to be the waterproof film component.

2. The manufacturing system according to claim 1, wherein the waterproof film component comprises:
a base layer;
a first hot melt adhesive layer, attached on the base layer; and
a second hot melt adhesive layer, attached on the first hot melt adhesive layer,
the first hot melt adhesive layer, the base layer, and the second hot melt adhesive layer are made of a homologous material, and
a melting point of the first hot melt adhesive layer is lower than a melting point of the second hot melt adhesive layer.

3. The manufacturing system according to claim 1, wherein the input roller assembly is configured to further convey a third hot melt adhesive film, the first hot melt adhesive film is located between the base film and the second hot melt adhesive film, and the second hot melt adhesive film is located between the first hot melt adhesive film and the third hot melt adhesive film.

4. The manufacturing system according to claim 1, wherein the ultrasonic device comprises a first roller, the hot roller device comprises a second roller, a first axle of the first roller is parallel or perpendicular to a second axle of the second roller.

5. The manufacturing system according to claim 4, wherein the hot roller device comprises:
a heating roller, disposed on one side of the pressing section; and
a belt, surrounding the second roller and the heating roller.

6. The manufacturing system according to claim 1, further comprising:
a hot air device, disposed at a front end of the pressing section.

7. A manufacturing method for a waterproof film component, the manufacturing method comprising:
simultaneously conveying a base film, a first hot melt adhesive film, and a second hot melt adhesive film to a pressing section;
using a first heating manner and an ultrasonic vibration heating manner to heat the base film, the first hot melt adhesive film, and the second hot melt adhesive film in the pressing section;
pressing the base film, the first hot melt adhesive film, and the second hot melt adhesive film to generate the waterproof film component in the pressing section.

8. The manufacturing method according to claim 7, wherein the using of the first heating manner and the ultrasonic vibration heating manner to heat the base film, the first hot melt adhesive film, and the second hot melt adhesive film in the pressing section further comprises:
heating the base film, the first hot melt adhesive film, and the second hot melt adhesive film by a predetermined temperature range to only make the first hot melt adhesive film be in a hot melt state,
wherein the predetermined temperature range is greater than or equal to a first melting temperature of the first hot melt adhesive film and equal to or less than a second melting temperature of the second hot melt adhesive film, and the second melting temperature is equal to the first melting temperature plus about 160° C.

9. The manufacturing method according to claim 7, wherein the first heating manner comprises:
using a hot roller device to contact and heat the base film, the first hot melt adhesive film, and the second hot melt adhesive film.

10. The manufacturing method according to claim 7, wherein the ultrasonic vibration heating manner comprises:
using an ultrasonic device to output a fixed power to vibrate and heat the base film, the first hot melt adhesive film, and the second hot melt adhesive film.
